(19) United States
(12) Patent Application Publication
(10) Pub. No.: US 2021/0409531 A1
(43) Pub. Date: Dec. 30, 2021

(54) MOBILE TERMINAL

(71) Applicant: LG ELECTRONICS INC., Seoul (KR)

(72) Inventors: Hongjo SHIM, Seoul (KR); Hyunwoo KIM, Seoul (KR); Seonghyok KIM, Seoul (KR); Sungwook CHANG, Seoul (KR)

(73) Assignee: LG ELECTRONICS INC., Seoul (KR)

(21) Appl. No.: 16/769,235

(22) PCT Filed: Jun. 18, 2019
(86) PCT No.: PCT/KR2019/007313

§ 371 Date: Jun. 2, 2020

(51) Int. Cl. H04M 1/02; H04N 5/225

(52) U.S. Cl. CPC H04M 1/0268; H04M 1/0237; H04M 2250/12; H04N 5/22525; H04M 1/0218

(57) ABSTRACT

The present disclosure provides a mobile terminal including a pair of bodies being folded around a hinge portion, a sensing unit for sensing a folded angle of the bodies, an obtaining unit for obtaining external information, a display for outputting visual information, and a controller connected to the sensing unit, the obtaining unit, and the display, wherein the controller controls the sensing unit to sense the continuously varying folded angle of the bodies, and controls the obtaining unit to obtain the external information corresponding to the sensed folded angle.

### TECHNICAL FIELD

The present disclosure relates to a mobile terminal. Specifically, a foldable mobile terminal that continuously senses a folded angle and obtains external information corresponding to the folded angle may be applied to the mobile terminal.

### BACKGROUND ART

Terminals may be generally classified as mobile/portable terminals or stationary terminals according to their mobility. Mobile terminals may also be classified as handheld terminals or vehicle mounted terminals according to whether or not a user can directly carry the terminal.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

As such functions become more diversified, the mobile terminal can support more complicated functions such as capturing images or video, reproducing music or video files, playing games, receiving broadcast signals, and the like. By comprehensively and collectively implementing such functions, the mobile terminal may be embodied in the form of a multimedia player or device.

Efforts are ongoing to support and increase the functionality of mobile terminals. Such efforts include software and hardware improvements, as well as changes and improvements in the structural components.

The mobile terminal has a limited size in consideration of portability. As the size of the mobile terminal is limited, it may be difficult to provide a wide screen to a user through a display provided in the mobile terminal. Accordingly, in recent years, a development of a foldable mobile terminal has been in progress to provide a larger screen to the user while improving the portability of the mobile terminal.

When a folded angle is precisely measured, the foldable mobile terminal has a room to provide various UIs/UXs correspondingly. Therefore, recently, efforts are being made to more precisely measure the folded angle of the foldable mobile terminal. Further, a more convenient UI/UX is currently being provided corresponding to the precisely measured folded angle.

### Disclosure

### Technical Problem

### A purpose of the present disclosure is to continuously sense a folded angle of a foldable mobile terminal in order to solve the aforementioned problem.

Further, another purpose of the present disclosure is to obtain external information corresponding to the folded angle, and to provide a useful UI/UX to a user based on the external information obtained corresponding to the folded angle.

### Technical Solutions

In order to achieve the above or other purposes, according to one aspect, the present disclosure provides a mobile terminal including a pair of bodies being folded around a hinge portion, a sensing unit for sensing a folded angle of the bodies, an obtaining unit for obtaining external information, a display for outputting visual information, and a controller connected to the sensing unit, the obtaining unit, and the display, wherein the controller controls the sensing unit to sense the continuously varying folded angle of the bodies, and controls the obtaining unit to obtain the external information corresponding to the sensed folded angle.

Further, according to one aspect, the present disclosure provides the mobile terminal characterized in that the hinge portion includes a pivot shaft rotating corresponding to the folded angle of the bodies, and the sensing unit includes an optical sensor for sensing an outer face of the pivot shaft, and obtains a rotation angle of the pivot shaft through the optical sensor to sense the folded angle of the bodies.

Further, according to one aspect, the present disclosure provides the mobile terminal characterized in that the hinge portion includes a sliding member moving corresponding to the folded angle of the bodies, and the sensing unit includes an optical sensor for sensing an outer face of the sliding member, and senses the folded angle of the bodies by obtaining a moved distance of the sliding member through the optical sensor.

Further, according to one aspect, the present disclosure provides the mobile terminal characterized in that the hinge portion includes a rotating gear rotating corresponding to the folded angle of the bodies, and the sensing unit senses the folded angle of the bodies by obtaining the number of teeth of the rotating gear passing a specific point.

Further, according to one aspect, the present disclosure provides the mobile terminal characterized in that the sensing unit includes a bridge protruding toward the rotating gear and having one end positioned between two adjacent teeth of the rotating gear, and a counter for counting the number of times one end of the bridge is in contact with a tooth of the rotating gear to sense a rotation angle of the rotating gear.

Further, according to one aspect, the present disclosure provides the mobile terminal characterized in that the counter senses a contact direction of the bridge to the teeth of the rotating gear to sense a rotation direction of the rotating gear.

Further, according to one aspect, the present disclosure provides the mobile terminal characterized in that the hinge portion includes a rotating gear rotating corresponding to the folded angle of the bodies, and the sensing unit includes a proximity sensor disposed on one side of the rotating gear, wherein the proximity sensor counts the number of times teeth of the rotating gear are close thereto to sense a rotation angle of the rotating gear.

Further, according to one aspect, the present disclosure provides the mobile terminal characterized in that the hinge portion includes a first rotating gear and a second rotating gear being engaged with each other and rotating corresponding to the folded angle of the bodies, that the sensing unit includes a first proximity sensor disposed on one side of the first rotating gear, and counting the number of times teeth of the first rotating gear are close thereto, and a second proximity sensor disposed on one side of the second rotating gear, and counting the number of times teeth of the second rotating gear are close thereto, and that the sensing unit senses rotation directions of the first rotating gear and the second rotating gear through a time difference between data respectively sensed by the first proximity sensor and the second proximity sensor.

Further, according to one aspect, the present disclosure provides the mobile terminal characterized in that the sensing unit includes an acceleration sensor for sensing acceleration of the mobile terminal and a gyro sensor for sensing a tilt of the mobile terminal, and the folded angle of the bodies is sensed through the acceleration sensor and the gyro sensor when a magnetic field sensed through the hall sensor is within a preset range.

Further, according to one aspect, the present disclosure provides the mobile terminal characterized in that the sensing unit merges data respectively obtained through the acceleration sensor and the gyro sensor with each other in a manner of compensating for the data to sense the folded angle of the bodies when sensing the folded angle of the bodies through the acceleration sensor and the gyro sensor.

Further, according to one aspect, the present disclosure provides the mobile terminal characterized in that the obtaining unit includes a first camera and a second camera respectively arranged on the pair of bodies, and the external information is image information obtained by merging first image information obtained from the first camera and second image information obtained from the second camera with each other corresponding to the sensed folded angle.

Further, according to one aspect, the present disclosure provides the mobile terminal characterized in that the controller controls the obtaining unit to obtain the merged image information through the first camera and the second camera in response to a single shooting command.

Further, according to one aspect, the present disclosure provides the mobile terminal characterized in that the controller controls the display to output an indicator indicating an angle for merging the first image information and the second image information with each other.

### Advantageous Effects

Effects of the mobile terminal according to the present disclosure are as follows.

The present disclosure relates to the foldable mobile terminal. The folded angle of the foldable mobile terminal may be continuously sensed.

In addition, the present disclosure may obtain the external information corresponding to the folded angle, and provide the useful UI/UX to the user corresponding to the obtained external information.

An additional scope of applicability of the present disclosure will become apparent from a detailed description below. However, various changes and modifications within the spirit and scope of the present disclosure may be clearly understood by those skilled in the art, so that it should be understood that a specific embodiment, such as a preferred embodiment of the detailed description and the present disclosure, is given by way of illustration only.

### DESCRIPTION OF DRAWINGS

FIG. 1 is a block diagram of a mobile terminal in accordance with the present disclosure.

FIG. 2 illustrates a view viewed from one direction in a state in which a foldable mobile terminal is unfolded, according to one embodiment of the present disclosure.

FIG. 3 illustrates a view viewed in a state in which a foldable mobile terminal is folded, according to one embodiment of the present disclosure.

FIG. 4 illustrates a view for describing an operation of a hinge module of a foldable mobile terminal, according to one embodiment of the present disclosure.

FIG. 5 illustrates a sensing unit for sensing an outer face of a pivot shaft included in a hinge portion through an optical sensor, according to one embodiment of the present disclosure.

FIG. 6 illustrates a pattern of light received corresponding to an outer face of a pivot shaft by a sensing unit in FIG. 5, according to one embodiment of the present disclosure.

FIG. 7 discloses a block diagram for describing a sensing unit in FIG. 4, according to one embodiment of the present disclosure.

FIGS. 8 and 9 illustrate other application examples of a sensing unit in FIG. 4 according to one embodiment of the present disclosure.

FIG. 10 illustrates an overall flowchart of sensing a folded angle through a sensing unit in FIG. 4 according to one embodiment of the present disclosure.

FIG. 11 illustrates a sensing unit that senses the number of teeth passing one point on a rotating gear included in a hinge portion, according to one embodiment of the present disclosure.

FIG. 12 is a view for describing a method for sensing a folding direction through a sensing unit in FIG. 11, according to one embodiment of the present disclosure.

FIGS. 13 to 14 illustrate a sensing unit for sensing rotation of rotating gears through proximity sensors, according to one embodiment of the present disclosure.

FIGS. 15 to 19 illustrate a sensing unit monitoring a folded angle through a magnet and a hall sensor, according to one embodiment of the present disclosure.

FIGS. 20 to 22 are views for describing an embodiment of sensing a folded angle using an acceleration sensor and a gyro sensor, according to one embodiment of the present disclosure.

FIGS. 23 to 25 are views for describing an embodiment of sensing a folded angle using a hall sensor, an acceleration sensor, and a gyro sensor, according to one embodiment of the present disclosure.

FIG. 26 is a view for describing a method for obtaining a panoramic image corresponding to a sensed folded angle, according to one embodiment of the present disclosure.

FIG. 27 is a view for describing a method for providing an indicator for obtaining a panoramic image, according to one embodiment of the present disclosure.

FIGS. 28 and 29 are views for describing a method for obtaining illuminance corresponding to a sensed folded angle, according to one embodiment of the present disclosure.

### BEST MODE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

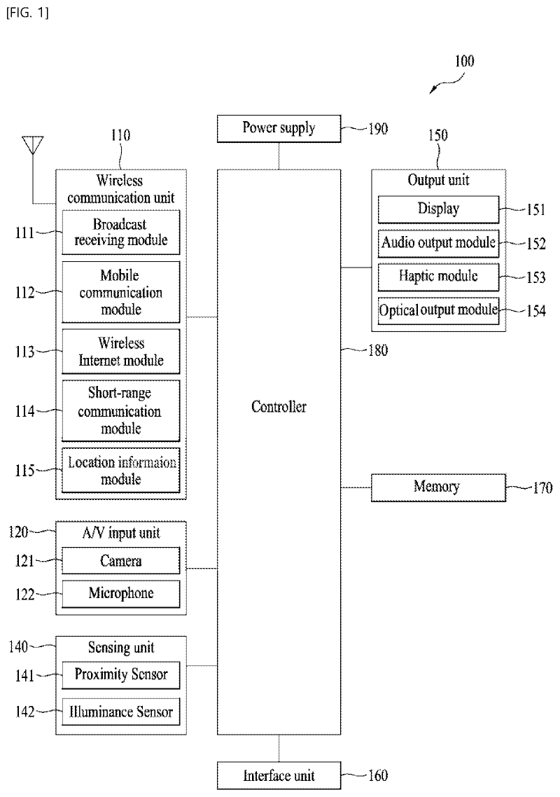

FIG. 1 is a block diagram of a mobile terminal in accordance with the present disclosure.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks.

To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output by the various components depicted in FIG. 1, or activating application programs stored in the memory 170.

The controller 180 controls some or all of the components illustrated in FIG. 1 according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least some of the components may operate in cooperation with each other to implement an operation, control, or control method of a mobile terminal according to various embodiments described below. Also, the operation, control, or control method of the mobile terminal may be implemented on the mobile terminal by driving at least one application program stored in the memory 170.

Hereinafter, the components listed above will be described in more detail.

Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000(Code Division Multi Access 2000), EV-DO(Enhanced Voice-Data Optimized or Enhanced Voice-Data Only), Wideband CDMA (WCDMA), High Speed Downlink Packet access (HSDPA), HSUPA(High Speed Uplink Packet Access), Long Term Evolution (LTE) , LTE-A(Long Term Evolution-Advanced), and the like). Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access.

This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA(High Speed Uplink Packet Access), Long Term Evolution (LTE), LTE-A(Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA,HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB(Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal. As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key

provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

The display unit 151 outputs information processed in the mobile terminal 100. The display unit 151 may be implemented using one or more suitable display devices.

Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

A power supply unit 190 for supplying power to the mobile terminal 100 may include a battery 191, which is mounted in the terminal body or detachably coupled to an outside of the terminal body.

The battery 191 may receive power via a power source cable connected to the interface unit 160. Also, the battery 191 can be recharged in a wireless manner using a wireless charger. Wireless charging may be implemented by magnetic induction or electromagnetic resonance.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

Further preferred embodiments will be described in more detail with reference to additional drawing figures. It is understood by those skilled in the art that the present features can be embodied in several forms without departing from the characteristics thereof.

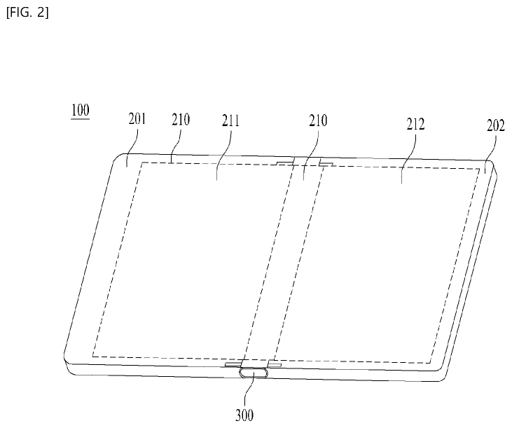

FIG. 2 illustrates a perspective view viewed from one direction in a state in which the foldable mobile terminal 100 is unfolded, according to one embodiment of the present disclosure. In this connection, the foldable mobile terminal 100 of the present disclosure, which is a kind of the mobile terminal 100 in FIG. 1, may include corresponding components.

The present disclosure is an invention associated with the foldable mobile terminal 100 including a pair of bodies 201 and 202 that are folded with respect to a hinge portion 300, and a display 210.

The pair of bodies 201 and 202 according to the present disclosure include a first body 201 and a second body 202 connected with each other through the hinge portion 300. The first body 201 and second body 202 may be overlapped with each other in a state in which the mobile terminal 100 according to the present disclosure is completely folded, and may form a plane in a state in which the mobile terminal 100 according to the present disclosure is completely unfolded.

The display 210 according to the present disclosure may output visual information, and may be folded together with the pair of bodies 201 and 202 that are folded to a flexible display. The display 201 may be disposed on one face of each of the pair of bodies 201 and 202. Specifically, the display 201 may include a first region 211 supported by the first body 201, a second region 212 supported by the second body 202, and a third region 213 corresponding to the hinge portion 300. In this connection, the third region 213 may be disposed between the first region 201 and the second region 202 and be folded and unfolded corresponding to a folding mechanism of the first body 201 and the second body 202.

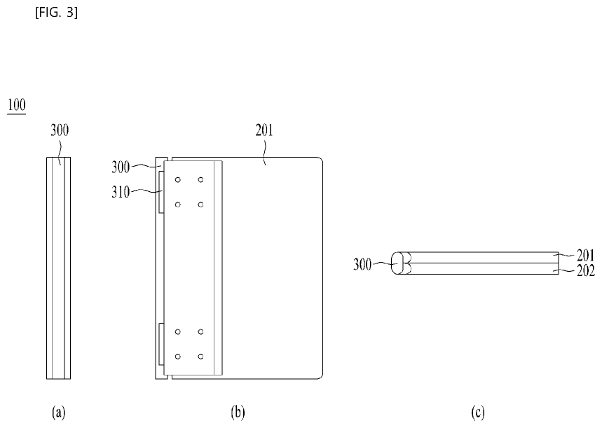

FIG. 3 illustrates a view viewed in a state in which a foldable mobile terminal is folded, according to one embodiment of the present disclosure. Specifically, (a) in FIG. 3 is a view of a side face of the foldable mobile terminal 100 on which the hinge portion 300 is disposed in the state in which the foldable mobile terminal 100 is folded. (b) in FIG. 3 is a view of a front face of the foldable mobile terminal 100 in the state in which the foldable mobile terminal 100 is folded. (c) in FIG. 3 is a view of a bottom side face of the foldable mobile terminal 100 in the state in which the foldable mobile terminal 100 is folded.

The mobile terminal 100 according to the present disclosure may be folded in an in-folding scheme or in an out-folding scheme. The in-folding scheme and the out-folding scheme may be divided by a direction in which the pair of bodies 201 and 202 are folded.

The in-folding scheme is a scheme in which the pair of bodies 201 and 202 are folded in a direction in which the display 201 (see FIG. 2) is disposed, and FIG. 3 illustrates the in-folding scheme. In the in-folding scheme, the display 201 is overlapped while being folded, so that the display 201 may not be exposed to outside. Further, the display 201 may be exposed to the outside in the unfolded state.

The out-folding scheme is a scheme in which the display 201 is folded in a direction opposite to the direction in which the display 201 is disposed. In the out-folding scheme, the pair of bodies 201 and 202 may be exposed to the outside in both the folded and unfolded states. The present disclosure, which is an invention characterized by sensing a folded angle and obtaining external information corresponding to the folded angle, may be applied to the out-folding scheme in addition to the in-folding scheme.

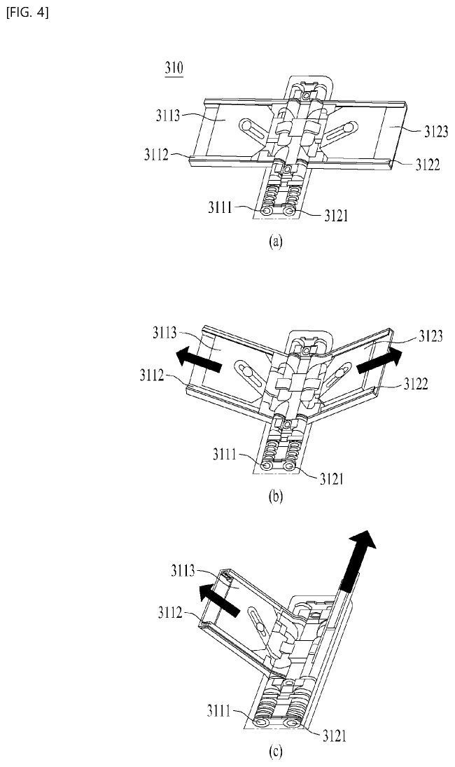

The foldable mobile terminal 100 has a problem in that a length of the display 201 should be compensated. In this regard, a hinge module 310 in FIG. 4 will be described in detail.

FIG. 4 illustrates a view for describing an operation of the hinge module 310 of the foldable mobile terminal 100, according to one embodiment of the present disclosure.

As the pair of bodies 201 and 202 are folded, the foldable mobile terminal 100 should compensate for the length of the flexible display 210 (see FIG. 2) disposed on one face of each of the pair of bodies 201 and 202.

The length compensation is to prevent the flexible display 210 from being wrinkled while the first body 201 and the second body 202 are folded. The reason why the flexible display 210 is wrinkled when the mobile terminal 100 is folded is as follows. A length of a straight line on the faces of the first body 201 and the second body 202 on which the flexible display 210 is disposed varies in the unfolded state and in the folded state. The length of the straight line is a length of a straight line connecting a first point on the face of the first body 201 on which the flexible display 210 is disposed with a second point on the face of the second body 201 on which the flexible display 210 is disposed. Because the length of the straight line is shorter in the folded state than in the unfolded state of the mobile terminal 100, when the length of the flexible display 210 is not compensated, the flexible display 210 is wrinkled when the mobile terminal 100 is folded.

The mobile terminal 100 according to the present disclosure may include the hinge module 310 including two shafts 3111 and 3121. The first body 201 may be linked with the first shaft 3111, and the second body 202 may be linked with the second shaft 2121. Specifically, the first body 201 may be connected to a first connecting member 3112 that pivots along the first shaft 3111 and pivot around the first shaft 3111. The second body 202 may be connected to a second connecting member 3122 that pivots along the second shaft 3121 and pivot around the second shaft 3121.

The hinge module 310 according to the present disclosure may include a first sliding member 3113 that slides in response to the pivoting of the first connecting member 3112. Likewise, the hinge module 310 according to the present disclosure may include a second sliding member 3123 that slides in response to the pivoting of the second connecting member 3122. The present disclosure may compensate for the length of the flexible display 210 through the first sliding member 3113 and the second sliding member 3123.

Specifically, a principle for mobile terminal according to the present disclosure to compensate for the length of the flexible display 210 through the first sliding member 3113 and the second sliding member 3123 is as follows. When the pair of bodies 201 and 202 are overlapped with each other, the first sliding member 3113 and the second sliding member 3123 may be moved to be farther away from the first shaft 3111 and the second shaft 3121, respectively, to prevent the display 210 from being wrinkled. (a) to (c) in FIG. 4 illustrate an embodiment in which the first sliding member 3113 and the second sliding member 3123 respectively move to be farther away from the first shaft 3111 and the second shaft 3121 in a process in which the hinge module 310 is folded. In addition, when the pair of bodies 201 and 202 are unfolded, the first sliding member 3113 and the second sliding member 3123 may move to approach the first shaft 3111 and the second shaft 3121, respectively, to prevent the display 210 from being broken. However, the present disclosure is for sensing the folded angle and obtaining the external information corresponding to the folded angle. The hinge module 310 is not limited to the embodiment in FIG. 4.

Hereinafter, a specific embodiment of sensing the folded angle in the foldable mobile terminal 100 according to the present disclosure will be described.

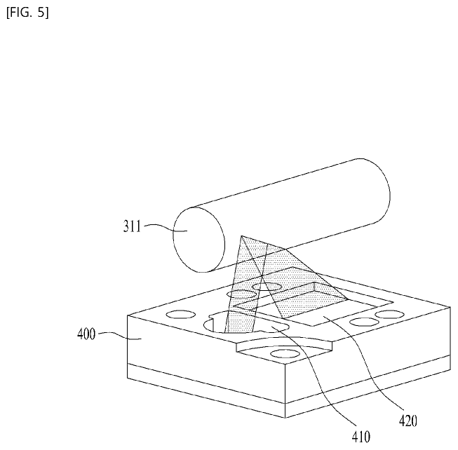

FIG. 5 illustrates a sensing unit 400 for sensing an outer face of a pivot shaft included in a hinge portion through an optical sensor, according to one embodiment of the present disclosure.

The foldable mobile terminal according to the present disclosure may include the sensing unit 400 that senses the folded angle.

The sensing unit 400 according to the present disclosure may be an optical sensor that senses an outer face of a pivot shaft 311 included in the hinge portion 300 (see FIG. 2). The pivot shaft 311 included in the hinge portion 300 according to the present disclosure, which is a component that rotates in response to the folded angle of the bodies 201 and 202 (see FIG. 2), may be at least one of the first shaft 3111 and the second shaft 3121.

The sensing unit 400 according to the present disclosure may include a light source 410 irradiating light toward the outer face of the pivot shaft 311 and a light receiver 420 receiving light reflected from the outer face of the pivot shaft 311. The light receiver 420 includes a plurality of pixels. The sensing unit 400 according to the present disclosure may sense the outer face of the pivot shaft 311 through a pattern of the light received by the plurality of pixels.

Specifically, the present disclosure may sense rotation angle and direction of the pivot shaft 311 through a degree of movement of the pattern of the light received through the plurality of pixels in the light receiver 420 of the sensing unit 400. The present disclosure may sense the rotation angle and direction of the pivot shaft 311 to sense the folded angle of the bodies 201 and 202.

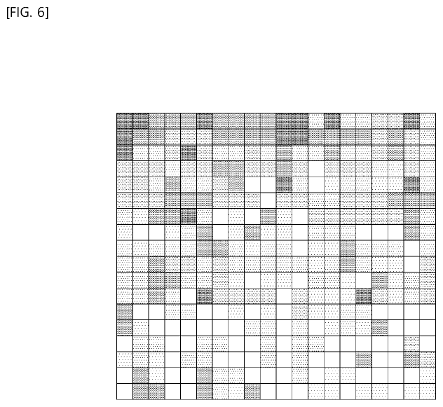

The pattern of the light received through the plurality of pixels in the light receiver 420 is specifically disclosed in FIG. 6.

FIG. 6 illustrates a pattern of light received corresponding to an outer face of a pivot shaft by a sensing unit in FIG. 5, according to one embodiment of the present disclosure.

The light receiver 420 (see FIG. 5) according to the present disclosure is composed of the plurality of pixels that receive the light. The plurality of pixels may differently implement the pattern of the received light corresponding to a face from which the light irradiated from the light source 410 (see FIG. 5) is reflected. The sensing unit 400 (see FIG. 5) according to the present disclosure may recognize the rotation angle and the rotation direction of the pivot shaft 311 (see FIG. 5) through the degree and a direction of movement of the pattern of the light.

A block diagram of the sensing unit recognizing the rotation angle and the rotation direction of the pivot shaft through the movement of the pattern of the light received by the light receiver 420 according to the present disclosure is as follows.

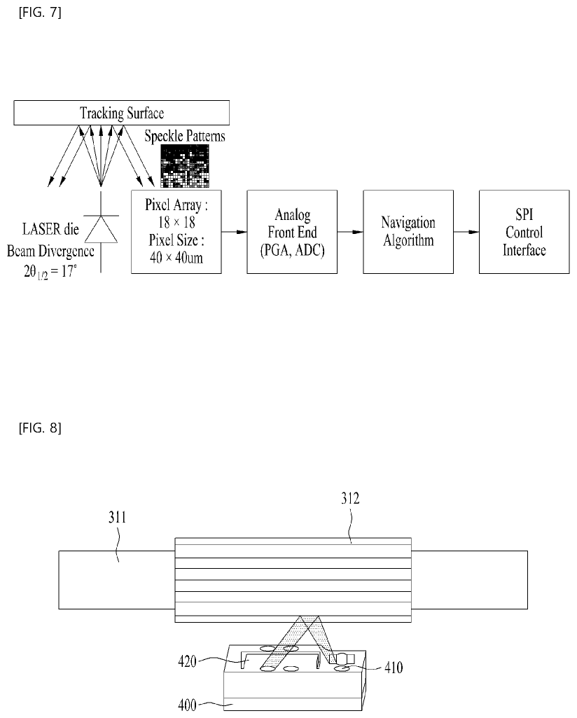

FIG. 7 discloses a block diagram for describing a sensing unit in FIG. 4, according to one embodiment of the present disclosure.

The sensing unit 400 according to the present disclosure may receive reflected light through a pixel array when light is irradiated to a tracking surface through a laser diode (a LASER die) using the optical sensor. An angle of irradiating the light from the laser diode (the LASER die) may be set based on a distance from the tracking surface. Specifically, FIG. 7 illustrates an embodiment of irradiating the light at the irradiation angle of 17 degrees through the laser diode (the LASER die). The pixel array may include a plurality of pixels corresponding to resolution. However, the present disclosure does not sense a specific surface of the outer face, but tracks a movement of the surface, so that the present disclosure does not need to have resolution higher than necessary. FIG. 7 illustrates an embodiment in which the pixel array has an 18x18 array and has a size of 40×40 um.

The sensing unit 400 according to the present disclosure may transmit an optical signal received through the pixel array to an analog front end (AFE) that amplifies (PGA) the optical signal and converts (ADC) the amplified optical signal into a digital signal. The signal distinguished by the AFE may sense a moved distance and a moved direction of the tracking surface through a navigation algorithm. The present disclosure may obtain the moved distance and direction by comparing surface information with previously stored data (a lookup table) through the navigation algorithm, or obtain the moved distance and direction by integrating. Information obtained through the navigation algorithm may be transmitted to a controller through a communication interface (a SPI Control Interface).

In this connection, the light source 410 in FIG. 5 may correspond to the laser diode (the LASER die), and the tracking surface may correspond to a surface of the pivot shaft 311. In addition, the light receiver 420, which is a component corresponding to the pixel array, may be a component including the AFE, the navigation algorithm, and the communication interface (the SPI Control Interface) in some cases. The navigation algorithm may transmit rotation angle and rotation direction information including diameter information of the pivot shaft 311 to the controller, or may obtain the rotation angle and the rotation direction information through the diameter information of the pivot shaft 311 from the controller.

Hereinabove, the embodiment in which the outer face of the pivot shaft 311 is sensed by the optical sensor to sense the rotation angle and direction is described, but the tracking surface is not limited to the outer face of the pivot shaft 311. Hereinafter, another embodiment of a tracking target will be described.

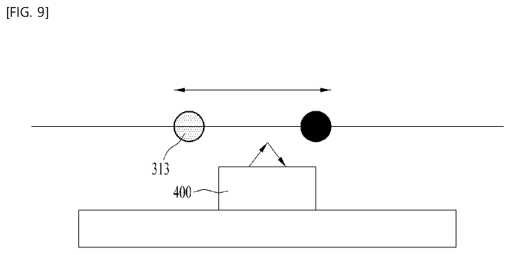

FIGS. 8 and 9 illustrate other application examples of a sensing unit in FIG. 4 according to one embodiment of the present disclosure.

Specifically, FIG. 8 illustrates an embodiment in which the tracking target having the outer face to be sensed by the sensing unit 400 is not limited to the pivot shaft 311 and an outer face of a rotating gear 312 is sensed. In the sensing unit 400, light irradiated from the light source 410 may be reflected on the outer face of the rotating gear 312 and received through the light receiver 420, and the rotation angle and the rotation direction of the pivot shaft 311 may be recognized through a movement of a pattern of the received light. Because the rotating gear 312 has teeth, it may be more easy to sense the outer face of the rotating gear 312 than to sense the outer face of the pivot shaft 311 through the optical sensor. That is, the sensing of the outer face of the rotating gear 312 may have an advantage of increasing a degree of freedom of resolution (the pixel array) of the light receiver 420.

Specifically, FIG. 9 illustrates an embodiment in which the tracking target having the outer face to be sensed through the sensing unit 400 is not limited to the rotating target and an outer face of the sliding member 313 is sensed. The sliding member 313, which is a component that moves corresponding to the folded angle of the bodies 201 and 202 according to the present disclosure, may specifically be one of the first sliding member 3113 and the second sliding member 3123 in FIG. 4. The sensing unit 400 may sense a moved distance and a moved direction of the sliding member 313 through a movement of a pattern of light reflected on the outer face of the sliding member 313 and sense a folded angle corresponding to the moved distance and the moved direction of the sliding member 313.

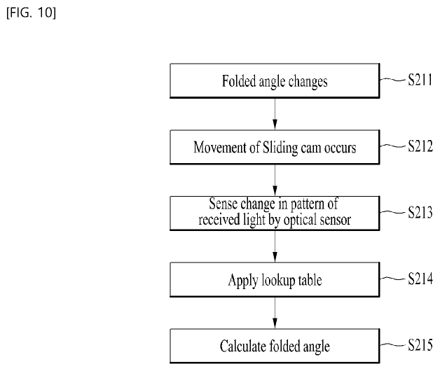

FIG. 10 illustrates an overall flowchart of sensing a folded angle through the sensing unit 400 in FIG. 4 according to one embodiment of the present disclosure.

The present disclosure is the foldable mobile terminal 100 (see FIG. 2). The folded angle may change corresponding to the folding mechanism of the pair of bodies 201 and 202 (see FIG. 2) (S211).

In the present disclosure, a movement of a sliding cam included in the hinge portion 300 (see FIG. 2) for connecting the pair of bodies 201 and 202 with each other may occur corresponding to the changed folded angle (S212). In this connection, the sliding cam, which is a component included in the hinge module 310 in FIG. 4, may be a component including the pivot shaft or the sliding member. Specifically, the pivot shaft may be one of the first shaft 3111 and the second shaft 3121 in FIG. 4. The sliding member may be one of the first sliding member 3113 and the second sliding member 3123 moving corresponding to the rotation angles of the first shaft 3111 and the second shaft 3121.

The sensing unit 400 according to the present disclosure may be an optical sensor that irradiates light and senses an outer face of the sliding cam. The present disclosure may sense a change in a pattern of light received by the optical sensor to sense the movement of the sliding cam (S213).

The mobile terminal 100 according to the present disclosure may include a memory storing data (a lookup table) in which the pattern of the received light and the folded angle are recorded to correspond to each other. That is, the present disclosure may apply the data (the lookup table) to the pattern of the received light sensed through the sensing unit 400 (S214) to calculate a corresponding folded angle (S215). In some cases, the present disclosure may calculate the folded angle by integrating the movement of the pattern of the received light. However, in this case, it is necessary to store a reference point of the integration in the memory.

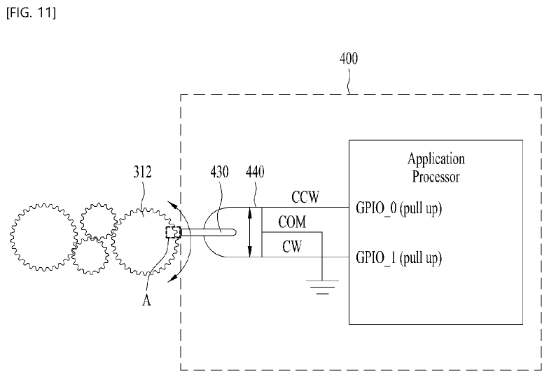

FIG. 11 illustrates the sensing unit 400 that senses the number of teeth passing one point on the rotating gear 312 included in the hinge portion 300, according to one embodiment of the present disclosure.

The hinge portion 300 (see FIG. 2) according to the present disclosure may include the rotating gear 312 that rotates corresponding to the folded angle of the pair of bodies 201 and 202.

The sensing unit 400 according to the present disclosure may sense the folded angle by measuring the number of teeth of the rotating gear 312 passing one point A. In addition, the sensing unit 400 according to the present disclosure may sense a folding direction through a direction in which the teeth of the rotating gear 312 pass the point A.

To this end, the sensing unit 400 according to the present disclosure may include a bridge 430 protruding toward the rotating gear 312 and having one end positioned between two adjacent teeth of the rotating gear 312, and a counter 440 for counting the number of times one end of the bridge 430 is in contact with a tooth of the rotating gear 312 to sense a rotation angle of the rotating gear 312. The counter 440 may calculate the number of teeth passing the point A through the number of times the other end of the bridge 430 is grounded to terminals CCW and CW, and calculate the rotation angle of the rotating gear 312 through the number of teeth passing the point A. Further, the counter 440 may include a first terminal CCW and a second terminal CW with the other end of the bridge 430 interposed therebetween. Therefore, the counter 440 according to the present disclosure senses a rotational direction of the rotating gear 312 through where the other end of the bridge 430 is grounded among the first terminal CCW and the second terminal unit CW. The other end of the bridge 430 may be grounded to the first terminal CCW or the second terminal CW corresponding to the direction in which one end of the bridge 430 is in contact with the tooth of the rotating gear 312.

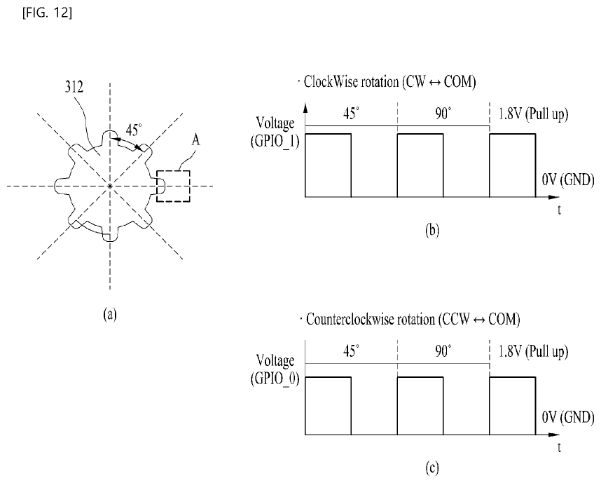

FIG. 12 is a view for describing a method for sensing a folding direction through the sensing unit 400 in FIG. 11, according to one embodiment of the present disclosure.

The rotating gear 312, which is included in the hinge portion 300 (see FIG. 2) according to the present disclosure and rotates corresponding to the folded angle of the pair of bodies 201 and 202 (in FIG. 2), may include a tooth for each preset angle. That is, the sensing unit 400 (see FIG. 11) according to the present disclosure may recognize the rotation angle of the rotating gear 312 through the number of teeth passing the point A, and may recognize the rotation direction of the rotating gear 312 by sensing the direction in which the teeth pass the point A.

Specifically, (a) in FIG. 12 illustrates an embodiment in which the rotating gear 312 includes the teeth for every 45 degrees. However, when the teeth are more densely arranged on the rotating gear 312, the sensing unit 400 according to the present disclosure may more precisely sense the rotation angle of the rotating gear 312, that is, the folded angle of the pair of bodies 201 and 202.

Specifically, (b) in FIG. 12 illustrates a signal generated when the other end of the bridge 430 (see FIG. 11) is grounded to the second terminal CW when the rotating gear 312 rotates clockwise. The rotating gear 312 in (a) in FIG. 12 has the teeth for every 45 degrees, so that a starting point of one waveform of the signal and a starting point of a next waveform may correspond to 45-degree rotation of the rotating gear 312. That is, the sensing unit 400 may recognize the rotation angle of the rotating gear 312 through the number of waveforms, and recognize the rotation speed through a time difference between the starting point of one waveform and the starting point of the next waveform. In addition, the sensing unit 400 may sense the rotation direction of the rotating gear 312 by sensing that the signal is generated by grounding the other end of the bridge 430 to the second terminal CW.

Specifically, (c) in FIG. 12 illustrates a signal generated by grounding the other end of the bridge 430 to the first terminal CCW when the rotating gear 312 rotates counterclockwise. As in the description of (b) in FIG. 12, the sensing unit 400 may recognize the rotation angle of the rotating gear 312 through the number of waveforms, and may recognize the rotation speed through the time difference between the starting point of one waveform and the starting point of the next waveform. In addition, the sensing unit 400 may sense the rotation direction of the rotating gear 312 by sensing that the signal is generated by grounding the other end of the bridge 430 to the first terminal CCW.

That is, the sensing unit 400 may sense the rotation angle of the rotating gear 312 based on which of the first and second terminals to which the other end of the bridge 430 is grounded to generate the signal.

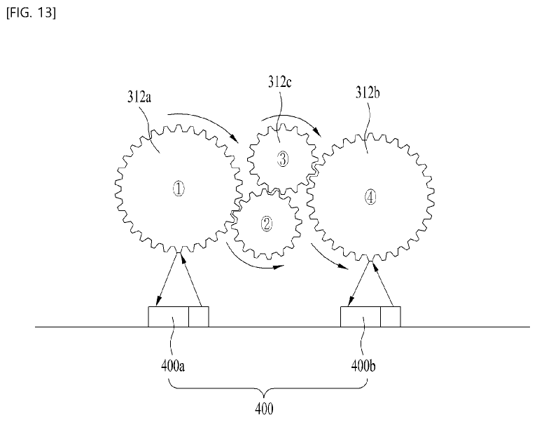

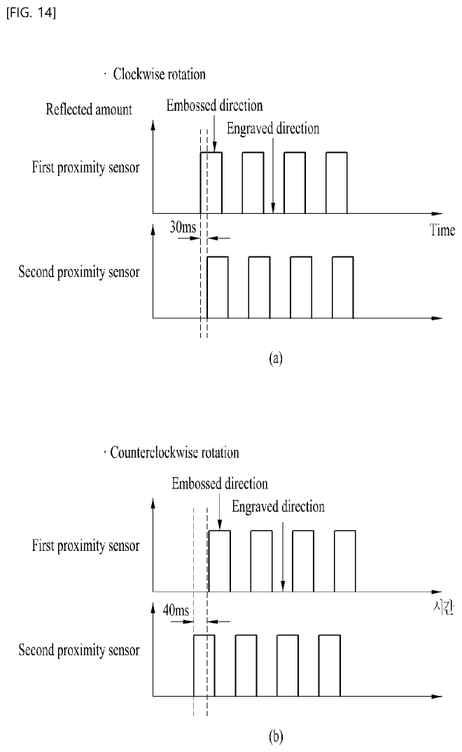

FIGS. 13 to 14 illustrate the sensing unit 400 for sensing rotation of rotating gears 312a and 312b through proximity sensors, according to one embodiment of the present disclosure.

When the sensing unit 400 according to the present disclosure is the optical sensor described in FIG. 5, a degree of precision may be high, but there may be disadvantages in that a volume of the mobile terminal 100 (specifically, a volume of the hinge portion 300) is increased to include the sensing unit 400 and a production cost is increased. In addition, when the sensing unit 400 according to the present disclosure corresponds to the sensing unit 400 described in FIG. 11, the degree of precision may be deteriorated and durability of the sensing unit 400 may be a problem.

Compensating for the above problem, the sensing unit 400 according to the present disclosure may include the proximity sensor disposed on one side of the rotating gears 312a and 312b, which rotate corresponding to the folded angle of the pair of bodies 201 and 202, and counting the number of times teeth of the rotating gears 312a and 312b are close thereto to sense rotation angles of the rotating gears 312a and 312b.

In addition, when the hinge portion 300 (see FIG. 2) according to the present disclosure includes a first rotating gear 312a and a second rotating gear 312b that are engaged with each other and rotate corresponding to the folded angle of the pair of bodies 201 and 202, the sensing unit 400 may include a first proximity sensor 400a disposed on one side of the first rotating gear 312a and counting the number of times teeth of the first rotating gear 312a are close thereto to sense a rotation angle of the first rotating gear 312a, and a second proximity sensor 400b disposed on one side of the second rotating gear 312b and counting the number of times teeth of the second rotating gear 312b are close thereto to sense a rotation angle of the second rotating gear 312b. The sensing unit 400 may sense rotation directions of the first rotating gear 312a and the second rotating gear 312b based on a time difference between data respectively sensed by the first proximity sensor 400a and the second proximity sensor 400b.

Specifically, the first rotating gear 312a and the second rotating gear 312b, which are engaged with each other to rotate corresponding to the folded angle and direction of the foldable mobile terminal 100, may have opposite rotation directions. For example, the first rotating gear 312a may be a component disposed on the first pivot shaft 3111 in FIG. 4, and the second rotating gear 312b may be a component disposed on the second pivot shaft 3121 in FIG. 4. The first rotating gear 312a and the second rotating gear 312b may be directly engaged with each other and rotated, or may be engaged with each other by an even number of connecting gears 312c and rotated.

Specifically, the first proximity sensor 400a may sense whether the teeth of the first rotating gear 312a are close thereto as the first rotating gear 312a rotates, and sense the number of times the teeth of the first rotating gear 312a are close thereto or the number of teeth passing one point to sense the rotation angle of the first rotation gear 312a.

Similarly, the second proximity sensor 400b may sense whether the teeth of the second rotating gear 312b are close thereto as the second rotating gear 312b rotates, and sense the number of times the teeth of the second rotating gear 312b are close thereto or the number of teeth passing one point to sense the rotation angle of the second rotation gear 312b.

The first proximity sensor 400a and the second proximity sensor 400b are sensors for respectively determining whether the first and second rotating gears 312a and 312b are respectively close to the first proximity sensor 400a and the second proximity sensor 400b based on amounts of reflected light with respect to light respectively irradiated by the first proximity sensor 400a and the second proximity sensor 400b. In the first proximity sensor 400a and the second proximity sensor 400b, a light receiver that receives the reflected light is not composed of a plurality of cells like the light receiver 420 in FIG. 5. Further, the first proximity sensor 400a and the second proximity sensor 400b are sensors that respectively determine whether the first and second rotating gears 312a and 312b are respectively close to the first proximity sensor 400a and the second proximity sensor 400b by simply comparing the amounts of light with a reference value. Therefore, the rotation direction of the first rotating gear 312a is not able to be recognized only by the first proximity sensor 400a, and the rotation direction of the second rotating gear 312b is not able to be recognized only by the second proximity sensor 400b. However, the first rotating gear 312a and the second rotating gear 312b are components that are engaged with each other. The rotation directions of the first rotating gear 312a and the second rotating gear 312b may be distinguished using a time difference of signals obtained by the first proximity sensor 400a and the second proximity sensor 400b.

The first rotating gear 312a and the second rotating gear 312b according to the present disclosure are components that are engaged with each other and rotate by the same angle in opposite directions. However, while the first rotating gear 312a rotates, a tooth of the first rotating gear 312a may be located at a different angle from a tooth of the second rotating gear 312b. The time difference may occur between when one tooth of the first rotating gear 312a is closest to the first proximity sensor 400a and when one tooth of the second rotating gear 312b is closest to the second proximity sensor 400b. The rotation directions of the first rotating gear 312a and the second rotating gear 312b may be sensed using the time difference. Hereinafter, a method for sensing the rotation directions of the first rotating gear 312a and the second rotating gear 312b will be described in detail.

(a) and (b) in FIG. 14 illustrate embodiments in which the time difference between the signals of the first proximity sensor 312a and the second proximity sensor 312b occurs corresponding to the rotation direction of the first rotating gear 312a. Specifically, (a) in FIG. 14 illustrates an embodiment in which the time difference of 30 ms occurs between the signal obtained from the first proximity sensor 400a and the signal obtained from the second proximity sensor 400b, and the signal of the first proximity sensor 400a precedes the signal of the second proximity sensor 400b when the first rotating gear 312a rotates clockwise. (b) in FIG. 14 illustrates an embodiment in which the time difference of 40 ms occurs between the signal obtained from the first proximity sensor 400a and the signal obtained from the second proximity sensor 400b, and the signal of the second proximity sensor 400b precedes the signal of the first proximity sensor 400a when the first rotating gear 312a rotates counterclockwise.

According to the embodiments in FIG. 14, when sensing that the signal obtained from the first proximity sensor 400a is 30 ms faster than the signal obtained from the second proximity sensor 400b, the sensing unit 400 may recognize that the first rotating gear 312a rotates clockwise and the second rotating gear 312b rotates counterclockwise. Similarly, when sensing that the signal obtained from the second proximity sensor 400b is 40 ms faster than the signal obtained from the first proximity sensor 400a, the sensing unit 400 may recognize that the first rotating gear 312a rotates counterclockwise and the second rotating gear 312b rotates clockwise.

That is, the sensing unit 400 according to the present disclosure may recognize the rotation directions of the first rotating gear 312a and the second proximity sensor 312b based on the time difference between the signals respectively obtained from the first proximity sensor 312a and the second proximity sensor 312b.

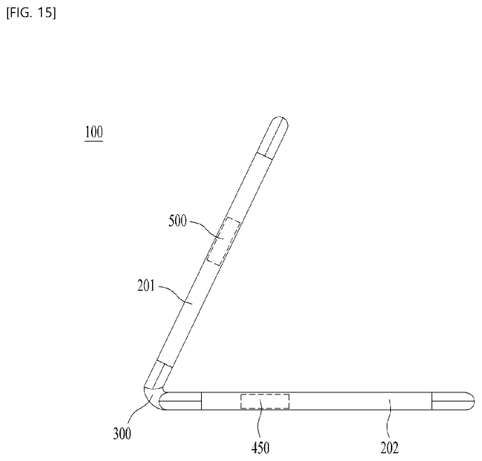

FIGS. 15 to 19 illustrate a sensing unit monitoring a folded angle through a magnet 500 and a hall sensor 450, according to one embodiment of the present disclosure.

The sensing unit 400 described above sets at least one of the shaft, the sliding member, and the rotating gear arranged in the hinge portion 300 as a sensing target. The sensing unit 400 described above needs to be disposed in the hinge portion 300. When the sensing unit 400 is disposed in the hinge portion 300, a configuration of the hinge portion 300 becomes too complicated or the mobile terminal 400 becomes large.

The sensing unit 400 according to the present disclosure may not set the component of the hinge portion 300 as the sensing target but set a magnetic field generated by the magnet 500 as the sensing target to sense the folded angle of the pair of bodies 201 and 202. Therefore, the disadvantages of complexifying the configuration of the hinge portion 300 and of increasing the volume of the mobile terminal 400 may be overcome.

Specifically, FIG. 15 illustrates an embodiment in which the magnet 500 is disposed in the first body 201 and the hall sensor 450 is disposed in the second body 202 in the mobile terminal 100. The hall sensor 450 may be the sensing unit 400 that senses the magnetic field generated by the magnet 500 to sense the folded angle of the pair of bodies 201 and 202. Because the hall sensor 450 according to the present disclosure does not need to be disposed in the hinge portion 300, a degree of freedom in placement in the configuration may be improved.

The hall sensor 450 according to the present disclosure may be disposed such that a distance h1 between the hall sensor 450 and a central axis 314 where the pair of bodies 201 and 202 are folded is different from a distance h2 between the magnet 500 and the central axis 314.

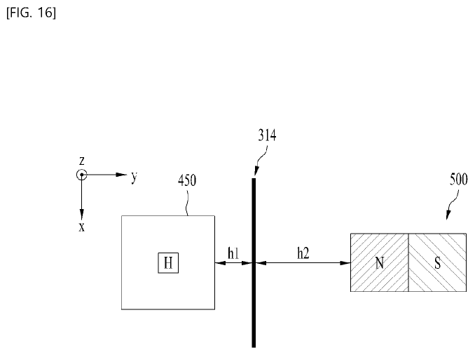

Specifically, FIG. 16 illustrates an embodiment in which the spaced distances of the hall sensor 450 and the magnet 500 with respect to the central axis 314 are different. When the spaced distances of the hall sensor 450 and the magnet 500 with respect to the central axis 314 are different, the distinguishing of the folded angle of the pair of bodies 201 and 202 may be easy. FIG. 16 illustrates an embodiment in which the central axis 314 is provided in an x-axis direction, and the hall sensor 450 and the magnet 500 are arranged in a y-axis direction. A method for distinguishing the angle by the hall sensor 450 using the above embodiment will be described below.

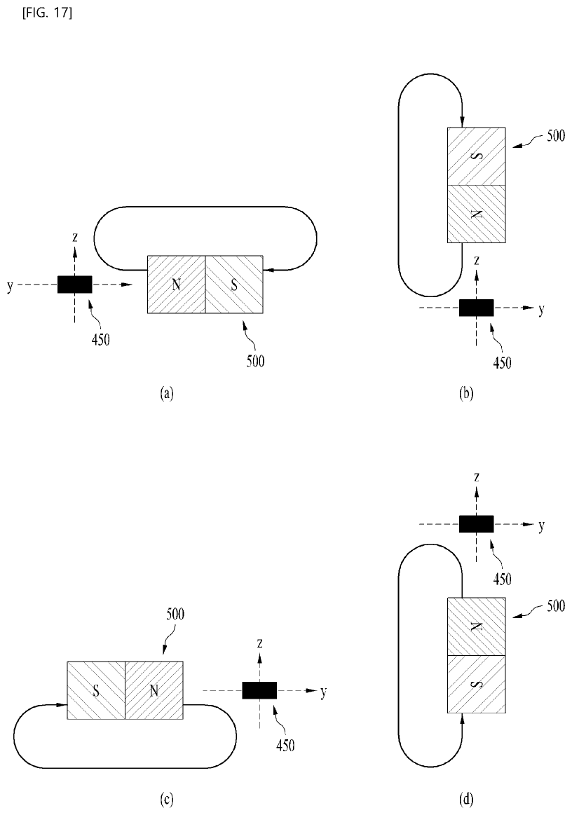

(a) in FIG. 17 illustrates an arrangement of the hall sensor 450 and the magnet 500 when the first body 201 and the second body 202 form a folded angle of 0 degrees, (b) in FIG. 17 illustrates the arrangement of the hall sensor 450 and the magnet 500 when the first body 201 and the second body 202 form a folded angle of 90 degrees, (c) in FIG. 17 illustrates the arrangement of the hall sensor 450 and the magnet 500 when the first body 201 and the second body 202 form a folded angle of 180 degrees, and (d) in FIG. 17 illustrates a case in which the first body 201 and the second body 202 form a folded angle of 270 degrees.

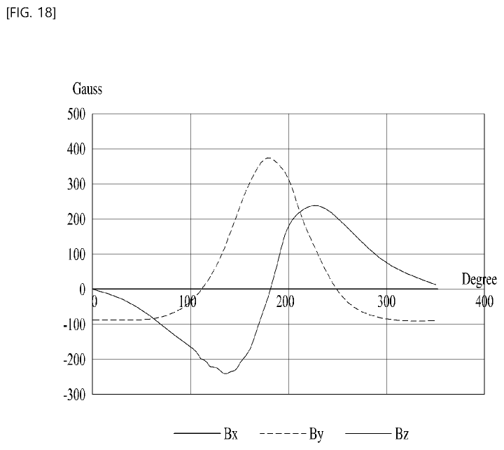

FIG. 18 illustrates a magnetic field Bx in an x-axis direction, a magnetic field By in a y-axis direction, and a magnetic field Bz in a z-axis direction corresponding to the folded angle of the first body 201 and the second body 202. Because the first body 201 and the second body 202 are folded around an x-axis, the magnetic field Bx in the x-axis direction does not change. However, it may be seen that a value of the magnetic field By in the y-axis direction increases as the folded angle increases from 0 to 180 degrees because the spaced distances h1 and h2 of the hall sensor 450 and the magnet 500 with respect to the central axis 314 are different from each other. The magnetic field Bz in the z-axis direction is characterized in that a direction of the magnetic field is reversed based on the folded angle of 180 degrees.

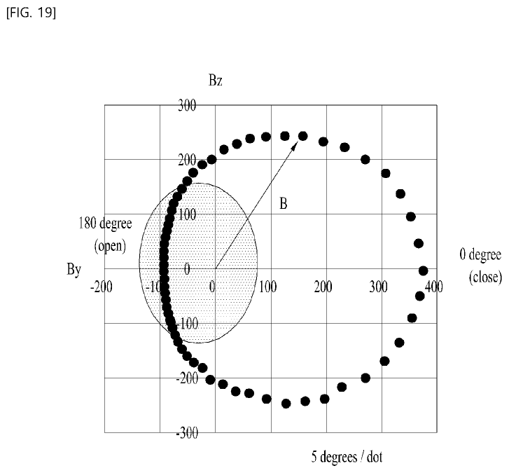

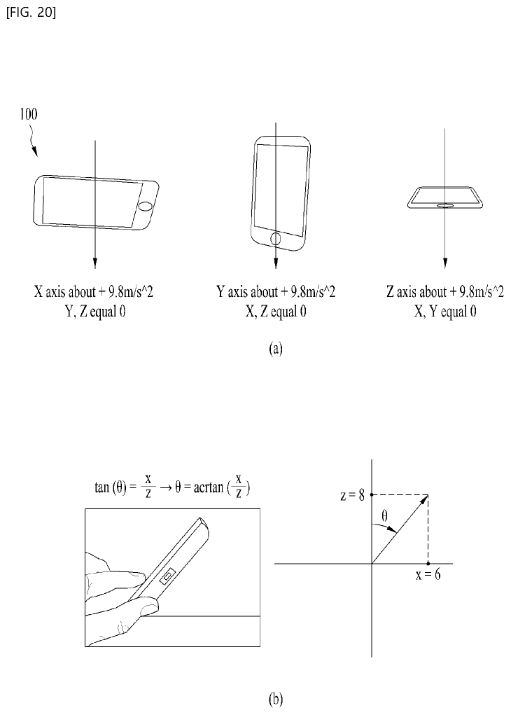

FIG. 19 illustrates a magnetic field sensed by the hall sensor 450 on y-z coordinates while the folded angle is changed from 0 to 360 degrees. A total magnetic field value B sensed by the hall sensor 450 may be represented as (Equation 1).

B=√(Bₓ²+B_{y}²B_{z}²) (Equation 1)

Because the magnetic field Bx in the x-axis direction does not vary, the magnetic field sensed by the hall sensor 450 may be displayed on the y-z coordinates. In this connection, the total magnetic field value B may be matched one-to-one with the folded angle of 0 to 180 degrees. That is, the hall sensor 450 may distinguish the folded angle of 0 to 180 degrees through the total magnetic field value B. However, when the folded angle is an angle between 120 degrees and 180 degrees, it may be difficult to distinguish the folded angle through the total magnetic field value B. Therefore, the present disclosure seeks to compensate for the difficulty of distinguishing the folded angle through the total magnetic field value B in a specific angle range through an acceleration sensor and a gyro sensor.

FIGS. 20 to 22 are views for describing an embodiment of sensing a folded angle using an acceleration sensor and a gyro sensor in addition to the hall sensor 450, according to one embodiment of the present disclosure.

Specifically, FIG. 20 is a view for describing a method for measuring a tilt of the mobile terminal 100 through the acceleration sensor. A sum of accelerations of axes in a stationary state is a gravitational acceleration value (9.8m/s\hat{ }2). A description in which a left and right direction of the mobile terminal 100 is set as the x-axis direction, an up and down direction is set as the y-axis direction, and a front and rear direction is set as the z-axis direction is as follows. As shown in (a) in FIG. 20, an x-axis directional component of the acceleration has the gravitational acceleration value when the mobile terminal 100 is standing in the x-axis direction, a y-axis directional component of the acceleration has the gravitational acceleration value when the mobile terminal 100 is standing in the y-axis direction, and a z-axis directional component of the acceleration has the gravitational acceleration value when the mobile terminal is lying in the z-axis direction. Therefore, as shown in (b) in FIG. 20, the tilt of the mobile terminal 100 may be obtained through a ratio of the axis-directional components of the acceleration. Accordingly, when the acceleration sensors are respectively arranged in the first body 201 and the second body 202, the folded angle of the first body 201 and the second body 202 may be sensed. However, the acceleration sensor has a disadvantage of inaccurate measurement in continuous movement.

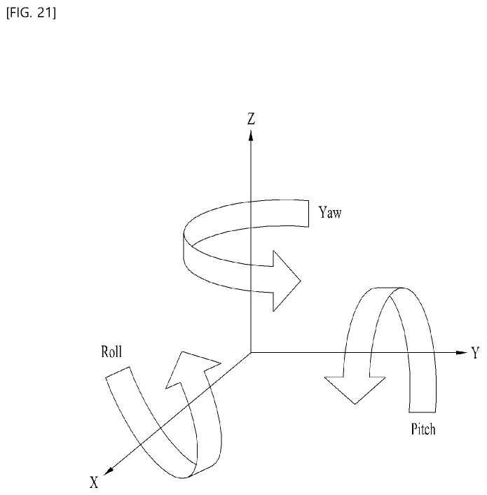

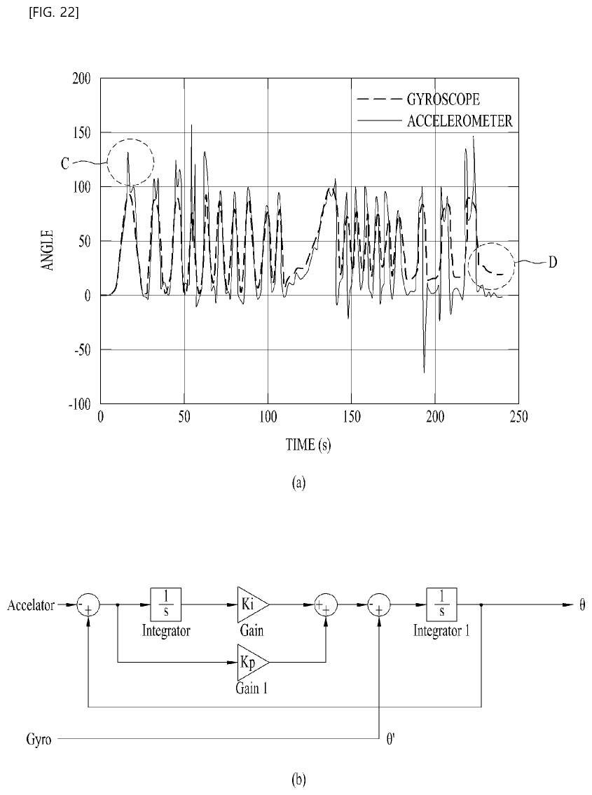

Specifically, FIG. 21 is a view for describing a method for measuring the tilt of the mobile terminal 100 through the gyro sensor. The gyro sensor may measure the tilt of the mobile terminal 100 by integrating rotation angle components (Yaw, Roll, and Pitch) of the respective axes. When the first body 201 and the second body 202 are respectively equipped with the gyro sensors, the folded angle of the first body 201 and the second body 202 may be sensed. However, the gyro sensor measures the tilt by integrating, so that errors may accumulate in a reference value.

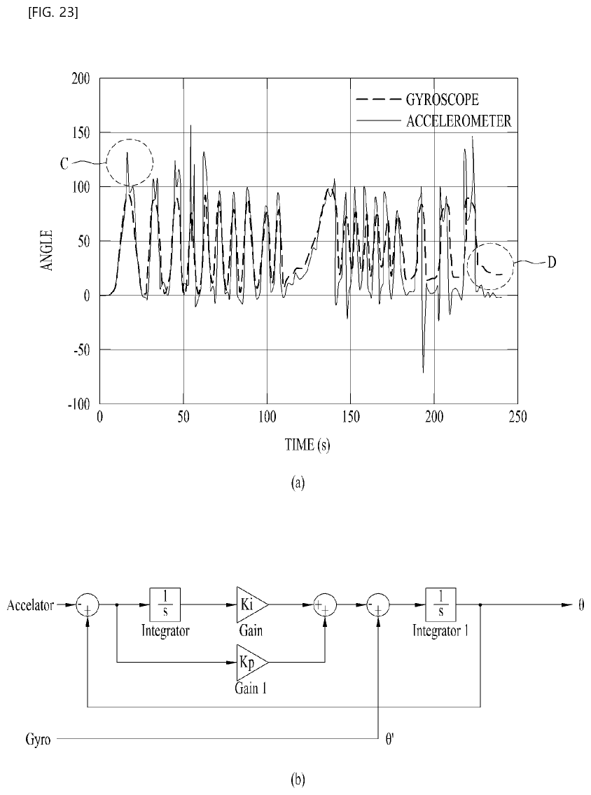

Specifically, (a) in FIG. 22 illustrates an embodiment of data measured by the acceleration sensor and the gyro sensor when folding the foldable mobile terminal 100 repeatedly at 0 degrees and 100 degrees. In a case of the acceleration sensor, inaccurate measurement values may be obtained for the continuous movement (see C). In addition, in a case of the gyro sensor, the reference value may be varied (see D). Conversely, the acceleration sensor has an advantage that the reference value is not varied, and the gyro sensor has an advantage of stably obtaining the data in the continuous movement. Therefore, the present disclosure seeks to improve an accuracy of the folded angle measurement by merging the data respectively obtained by both the acceleration sensor and the gyro sensor with each other in a manner of compensating for the data. Specifically, the present disclosure may merge the data respectively obtained from the gyro sensor and the acceleration sensor with each other in the manner of compensating for the data through at least one of a complementary filter and a Kalman filter. Specifically, (b) in FIG. 22 illustrates an embodiment of compensating for the data obtained from the acceleration sensor and the gyro sensor with the complementary filter and the Kalman filter.

However, the method for calculating the folded angle through the gyro sensor and the acceleration sensor has disadvantages in that the accuracy is lower than the method using the hall sensor 450 and a calculation amount is large. Therefore, it may be preferable to fundamentally distinguish the folded angle through the hall sensor 450 and complementarily use the gyro sensor and the acceleration sensor when the folded angle is difficult to be distinguished through the hall sensor 450.

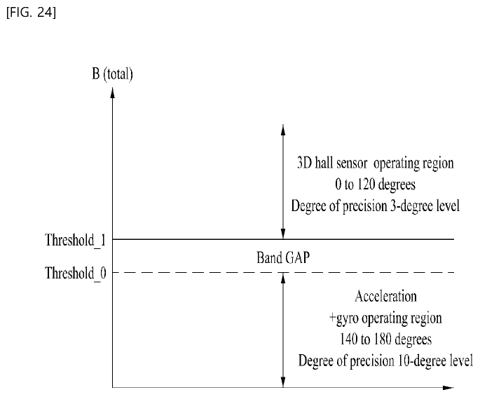

FIGS. 23 to 25 are views for describing an embodiment of sensing a folded angle using a hall sensor, an acceleration sensor, and a gyro sensor, according to one embodiment of the present disclosure. Hereinafter, the hall sensor is a component corresponding to the hall sensor 450 described with reference to FIGS. 15 to 19, and the acceleration sensor and the gyro sensor are components corresponding to the acceleration sensor and the gyro sensor described with reference to FIGS. 20 to 22.

Referring to FIG. 23, an embodiment of sensing the folded angle will be described as follows. The present disclosure relates to the foldable mobile terminal 100. The folded angle of the bodies 201 and 202 may change based on use (S221). The hall sensor 450 disposed in one of the first body 201 and the second body 202 may sense a magnetic field value of the magnetic field generated by the magnet 500 disposed in the other in response to the change in the folded angle (S222). In this connection, the magnetic field value may be the total magnetic field value B described in FIG. 19. Corresponding to the arrangement of the hall sensor 450 and the magnet 500 described in FIG. 16, the magnetic field value may decrease as the folded angle changes from 0 to 180 degrees. However, it may be difficult to sense the folded angle through the hall sensor 450 at an angle equal to or above a specific angle in a range of 0 to 180 degrees. Therefore, when the magnetic field value sensed through the hall sensor 450 is equal to or greater than a preset value (S223, Yes), the folded angle may be sensed through the hall sensor 450 (S224). When the magnetic field value sensed through the hall sensor 450 is equal to or less than the preset value (S223, No), a rotation vector is detected through the acceleration and the gyro sensor (S225), and the detected value is corrected (S226), so that the folded angle may be sensed (S227).

The sensing of the folded angle through the acceleration sensor and the gyro sensor has the disadvantage in that the calculation amount is large in addition to the disadvantage in that the accuracy is lower than when the folded angle is sensed through the hall sensor 450. Therefore, it may be preferable to use the acceleration sensor and the gyro sensor as limited as possible. To this end, it may be preferable to have a plurality of preset values in FIG. 23.

Specifically, FIG. 24 illustrates an embodiment in which the acceleration sensor and the gyro sensor are limitedly used through a first preset value (a Threshold_1) and a second preset value (a Threshold_2). When the magnetic field value measured by the hall sensor 450 is greater than the first preset value (the Threshold_1) (e.g., the folded angle is between 0 and 120 degrees), because of high degree of precision and high distinguish power, the folded angle may be sensed through the hall sensor 450. When the magnetic field value measured by the hall sensor 450 is less than the second preset value (the Threshold_2) (e.g., the folded angle is between 140 and 180 degrees), the folded angle may be sensed through the acceleration sensor and the gyro sensor. When the magnetic field value measured by the hall sensor 450 is between the first preset value (the Threshold_1) and the second preset value (the Threshold_2), the folded angle may be measured through the hall sensor 450, and the distinguish power may be increased by reducing the degree of precision. That is, the degree of precision for distinguishing through the hall sensor 450 may be lower than the degree of precision of sensing the folded angle through the acceleration sensor and the gyro sensor below the second preset value (the Threshold_2).

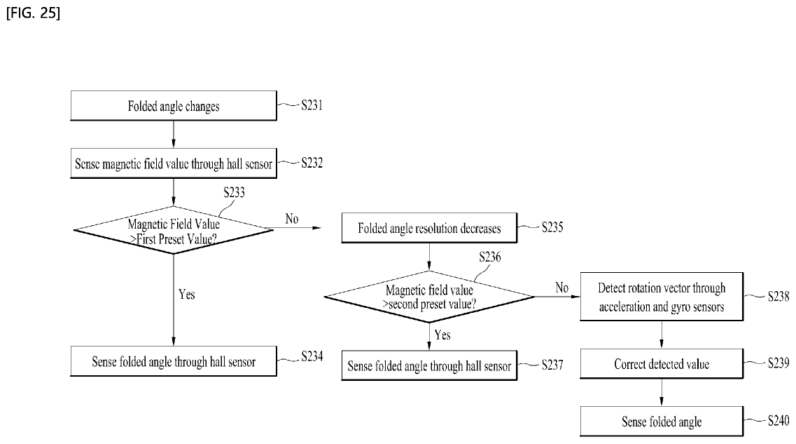

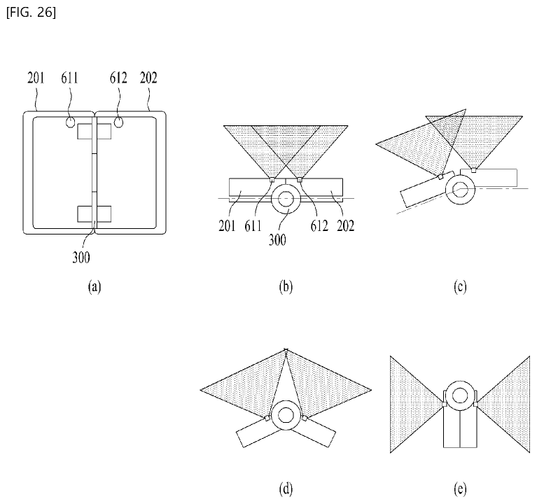

Specifically, a description of an embodiment of sensing a folded angle with reference to FIG. 25 is as follows. The present disclosure relates to the foldable mobile terminal 100. The folded angle of the bodies 201 and 202 may change based on the use (S231). The hall sensor 450 disposed in one of the first body 201 and the second body 202 may sense a magnetic field value of the magnetic field generated by the magnet 500 disposed in the other in response to the change in the folded angle (S232). In this connection, the magnetic field value may be the total magnetic field value B described in FIG. 19. Corresponding to the arrangement of the hall sensor 450 and the magnet 500 described in FIG. 16, the magnetic field value may decrease as the folded angle changes from 0 to 180 degrees. However, it may be difficult to sense the folded angle through the hall sensor 450 at the angle equal to or above the specific angle in the range of 0 to 180 degrees. Therefore, when the magnetic field value sensed through the hall sensor 450 is equal to or greater than the preset value (S233, Yes), the folded angle may be sensed through the hall sensor 450 (S234). When the magnetic field value sensed through the hall sensor 450 is equal to or less than the preset value (S233, No), the folded angle distinguish power may be low. However, when the degree of precision of the folded angle is decreased, the distinguish power may be increased. Therefore, the degree of precision of the folded angle is reduced and the magnetic field value is obtained through the hall sensor 450 (S235). When the magnetic field value is equal to or greater than the second preset value (S236, Yes), the folded angle may be sensed through the hall sensor 450 (S237). In this connection, the second preset value may be smaller than the first preset value. When the magnetic field value obtained through the hall sensor 450 is equal to or less than the second preset value (S236, No), the degree of precision of sensing the folded angle through the hall sensor may be lower than the degree of precision of sensing the folded angle through the acceleration sensor and the gyro sensor. Therefore, when the magnetic field value obtained through the hall sensor 450 is equal to or less than the second preset value (S236, No), the rotation vector is detected through the acceleration sensor and the gyro sensor (S238), the detected value is corrected (S239) to increase the degree of precision, and the folded angle may be sensed (S240).

The characteristic of the present disclosure of continuously or precisely measuring the folded angle in the foldable mobile terminal was described above. Hereinafter, an embodiment in which information is obtained corresponding to the folded angle and an UI/UX is provided corresponding to the obtained information will be described.

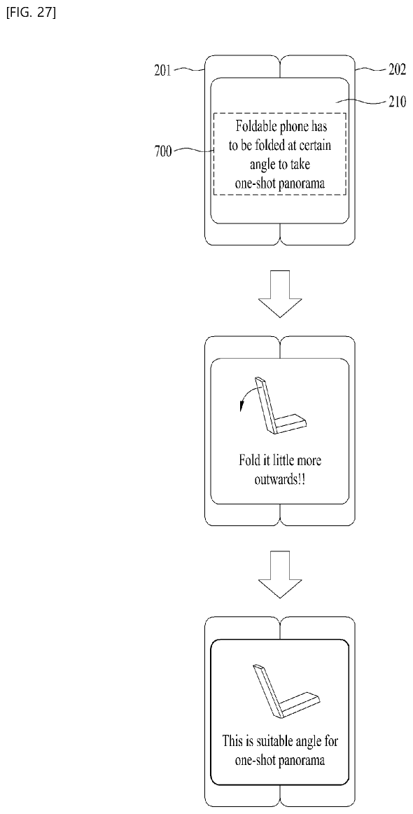

FIG. 26 is a view for describing a method for obtaining a panoramic image corresponding to a sensed folded angle, according to one embodiment of the present disclosure.

The present disclosure relates to the foldable mobile terminal, which may include an obtaining unit that obtains the external information, and may obtain the external information corresponding to the folded angle. The obtaining unit may be a camera, and the external information may be image information obtained through the camera.

Referring to (a) in FIG. 26, the first body 201 and the second body 202 are connected to each other by the hinge portion 300 and folded. The first body 201 may include a first camera 611 and the second body 202 may include a second camera 612. In this connection, the first camera 611 and the second camera 612 may be arranged to be directed in the same direction while the first body 201 and the second body 202 are unfolded as shown in (b) in FIG. 26. The present disclosure may obtain image information obtained by merging first image information obtained from the first camera 611 and second image information obtained from the second camera 612 with each other corresponding to the sensed folded angle. In this connection, the merged image information may be a panoramic image or a wide area image.

Specifically, when the folded angle of the first body 201 and the second body 202 forms 180 degrees ((b) in FIG. 26), angles of view of the first camera 611 and the second camera 612 overlap substantially, so that there may be less practical benefit of merging the first image information and the second image information with each other. When the folded angle of the first body 201 and the second body 202 forms 150 degrees ((c) in FIG. 26), the angles of view of the first camera 611 and the second camera 612 may overlap with each other to be suitable for obtaining the wide area image. In addition, when the folded angle of the first body 201 and the second body 202 forms 110 degrees ((d) in FIG. 26), the angles of view of the first camera 611 and the second camera 612 may overlap with each other to be suitable for obtaining the panoramic image. However, when the folded angle of the first body 201 and the second body 202 forms an angle equal to or less than a specific angle (e.g., 0 degrees) ((e) in FIG. 26), the angles of view of the first camera 611 and the second camera 612 may not overlap with each other or may be less overlapped with each other such that it is difficult to merge the first image information and the second image information with each other.

That is, the present disclosure may recognize the folded angle of the first body 201 and the second body 202, and obtain the wide area image or the panoramic image information through the first camera 611 and the second camera 612 respectively arranged on the first body 201 and the second body 202 through one time shooting corresponding to the recognized folded angle.

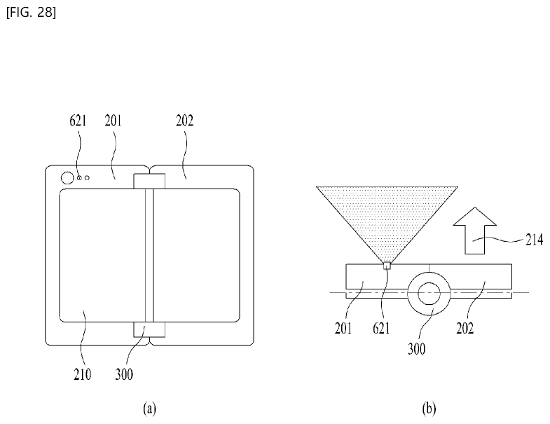

FIG. 27 is a view for describing a method for providing an indicator for obtaining a panoramic image, according to one embodiment of the present disclosure.

The present disclosure relates to the foldable mobile terminal. The display 210 may be disposed on one face of each of the pair of bodies 201 and 202 that are folded.

The foldable mobile terminal of the present disclosure may recognize the folded angle through the sensing unit and output a preview of the panoramic image or the wide area image described in FIG. 26 on the display 210.

In addition, the foldable mobile terminal according to the present disclosure may recognize the folded angle through the sensing unit, and output an indicator 700 indicating an angle for obtaining the panoramic image or the wide area image described in FIG. 26 on the display 210. For example, when the user selects panoramic image shooting or wide area image shooting, the indicator 700 may instruct the user to fold the foldable mobile terminal. In this connection, the indicator 700 according to the present disclosure may indicate a folding direction or a folding angle to the user. Alternatively, the indicator 700 according to the present disclosure may allow the user to recognize that an angle is suitable for the panoramic image shooting or the wide area image shooting.

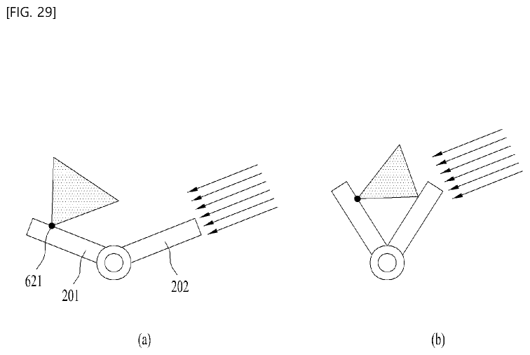

FIGS. 28 and 29 are views for describing a method for obtaining illuminance corresponding to a sensed folded angle, according to one embodiment of the present disclosure.

The present disclosure relates to the foldable mobile terminal, which may include the obtaining unit that obtains the external information, and may obtain the external information corresponding to the folded angle. The obtaining unit may be an illuminance sensor, and the external information may be ambient brightness information obtained through the illuminance sensor.

The present disclosure relates to the foldable mobile terminal, which may include the pair of bodies 201 and 202 that are folded by the hinge portion 300, and the display 210 on one face of each of the pair of bodies 201 and 202. The display 210 may output the image information, and output brightness 214 may be controlled by the ambient brightness information obtained through an illuminance sensor 621.

The present disclosure relates to the foldable mobile terminal. When the pair of bodies 201 and 202 are folded, the illuminance sensor 621 may obtain the ambient brightness information corresponding to the folded angle. An amount of ambient light incident on the illuminance sensor 621 for each unit area may be varied corresponding to the folded angle. Therefore, the present disclosure may obtain the ambient brightness information using an amount of light sensed by the illuminance sensor 621 and the folded angle. For example, when the folded angle is within a preset range, the ambient brightness information may be obtained by adding a correction value corresponding to the folded angle to the amount of light sensed by the illuminance sensor 621.

Specifically, as the folded angle is smaller, the ambient brightness information may be obtained by adding a larger correction value to the amount of light sensed by the illuminance sensor 621. This is because the amount of light sensed by the illuminance sensor 621 disposed on the first body 201 may be reduced because the ambient light is covered by the second body 202 as shown in FIG. 29.

The above detailed description should not be construed as limiting in all respects, but should be considered illustrative. The scope of the present disclosure should be determined by rational interpretation of the appended claims, and all changes within the equivalent scope of the present disclosure are included in the scope of the present disclosure.

1. A mobile terminal comprising:
a pair of bodies being folded around a hinge portion;
a sensing unit for sensing a folded angle of the bodies;
an obtaining unit for obtaining external information;
a display for outputting visual information; and
a controller connected to the sensing unit, the obtaining unit, and the display,
wherein the controller is configured to:
control the sensing to sense the continuously varying folded angle of the bodies; and
control the obtaining unit to obtain the external information corresponding to the sensed folded angle.

2. The mobile terminal of claim 1, wherein the hinge portion includes a pivot shaft rotating corresponding to the folded angle of the bodies, and
wherein the sensing unit includes an optical sensor for sensing an outer face of the pivot shaft, and obtains a rotation angle of the pivot shaft through the optical sensor to sense the folded angle of the bodies.

3. The mobile terminal of claim 1, wherein the hinge portion includes a sliding member moving corresponding to the folded angle of the bodies, and
wherein the sensing unit includes an optical sensor for sensing an outer face of the sliding member, and senses the folded angle of the bodies by obtaining a moved distance of the sliding member through the optical sensor.

4. The mobile terminal of claim 1, wherein the hinge portion includes a rotating gear rotating corresponding to the folded angle of the bodies, and
wherein the sensing unit senses the folded angle of the bodies by obtaining the number of teeth of the rotating gear passing a specific point.

5. The mobile terminal of claim 4, wherein the sensing unit includes:
a bridge protruding toward the rotating gear and having one end positioned between two adjacent teeth of the rotating gear; and
a counter for counting the number of times one end of the bridge is in contact with a tooth of the rotating gear to sense a rotation angle of the rotating gear.

6. The mobile terminal of claim 5, wherein the counter senses a contact direction of the bridge to the teeth of the rotating gear to sense a rotation direction of the rotating gear.

7. The mobile terminal of claim 1, wherein the hinge portion includes a rotating gear rotating corresponding to the folded angle of the bodies, and
wherein the sensing unit includes a proximity sensor disposed on one side of the rotating gear, wherein the proximity sensor counts the number of times teeth of the rotating gear are close thereto to sense a rotation angle of the rotating gear.

8. The mobile terminal of claim 7, wherein the hinge portion includes a first rotating gear and a second rotating gear being engaged with each other and rotating corresponding to the folded angle of the bodies,
wherein the sensing unit includes:
a first proximity sensor disposed on one side of the first rotating gear, and counting the number of times teeth of the first rotating gear are close thereto; and
a second proximity sensor disposed on one side of the second rotating gear, and counting the number of times teeth of the second rotating gear are close thereto, and
wherein the sensing unit senses rotation directions of the first rotating gear and the second rotating gear through a time difference between data respectively sensed by the first proximity sensor and the second proximity sensor.

9. The mobile terminal of claim 1, wherein the pair of bodies include:
a first body including a magnet; and
a second body including a hall sensor, and
wherein the sensing unit senses a magnetic field generated by the magnet through the hall sensor to sense the folded angle of the bodies.

10. The mobile terminal of claim 9, wherein the sensing unit includes an acceleration sensor for sensing acceleration of the mobile terminal and a gyro sensor for sensing a tilt of the mobile terminal, and
wherein the folded angle of the bodies is sensed through the acceleration sensor and the gyro sensor when a magnetic field sensed through the hall sensor is within a preset range.

11. The mobile terminal of claim 10, wherein the sensing unit merges data respectively obtained through the acceleration sensor and the gyro sensor with each other in a manner of compensating for the data to sense the folded angle of the bodies when sensing the folded angle of the bodies through the acceleration sensor and the gyro sensor.

12. The mobile terminal of claim 1, wherein the obtaining unit includes a first camera and a second camera respectively arranged on the pair of bodies, and
wherein the external information is image information obtained by merging first image information obtained from the first camera and second image information obtained from the second camera with each other corresponding to the sensed folded angle.

13. The mobile terminal of claim 12, wherein the controller is configured to control the display to output a preview of the merged image information corresponding to the sensed folded angle.

14. The mobile terminal of claim 12, wherein the controller is configured to control the display to output an indicator indicating an angle for merging the first image information and the second image information with each other.

15. The mobile terminal of claim 1, wherein the obtaining unit includes an illuminance sensor for sensing ambient brightness, and
wherein the external information is ambient brightness information obtained by correcting the ambient brightness information obtained from the illuminance sensor corresponding to the sensed folded angle.
